(19) United States
(12) Patent Application Publication
(10) Pub. No.: US 2022/0356844 A1
(43) Pub. Date: Nov. 10, 2022

(54) HEAT EXCHANGE DEVICE AND AIRCRAFT TURBINE ENGINE WITH THE DEVICE

(71) Applicant: SAFRAN AERO BOOSTERS S.A., Herstal (BE)

(72) Inventors: Gilles Ayoub, Herstal (BE); David Weicker, Herstal (BE); Alexandre Carre, Herstal (BE); Rémy Henri Pierre Princivalle, Herstal (BE)

(73) Assignee: SAFRAN AERO BOOSTERS S.A., Herstal (BE)

(21) Appl. No.: 17/736,800

(22) Filed: May 4, 2022

(30) Foreign Application Priority Data
May 6, 2021 (BE) 2021/5368

(51) Int. Cl. F02C 7/18; F02C 7/04

(52) U.S. Cl. CPC F02C 7/18; F02C 7/04; F05D 2260/20; F05D 2220/323

(57) ABSTRACT

Heat exchange devices for aircraft turbine engines include a heat exchanger and an inlet scoop comprising an air intake configured for supplying the heat exchanger. The air intake of the inlet scoop is divided into several mouthpieces, each defining an air flux supplying the heat exchanger.

### CROSS REFERENCE TO RELATED APPLICATION

This application claims priority under 35 U.S.C. §119 to Belgian Patent Application No. 6E2021/5368, filed May 6, 2021, the entire disclosure of which is hereby incorporated by reference.

### TECHNICAL FIELD

The present invention relates to a heat exchange device and an aircraft turbine engine with the heat exchange device.

### BACKGROUND

There are so-called scoop heat exchangers, i.e., taking part of the air from the secondary flux and reinjecting the air which has passed through a heat exchanger into this secondary flux. According to FIG. 1, such an exchanger 10 is supplied with air via an inlet scoop 12. As the scoop is steep, the air velocity profile at the inlet of the exchanger 10 is unbalanced according to the height of the exchanger; in particular, the velocity profile is high in the centre of the exchanger but not at the top and bottom of the exchanger in FIG. 1.

The disadvantage of these devices is that the imbalance caused by the velocity gradient of the air at the exchanger inlet does not allow the heat exchanged in the exchanger to be maximized, as not enough air enters the whole exchanger.

There is a need for a more efficient heat exchange device.

### SUMMARY OF THE INVENTION

To this end, the present disclosure proposes a heat exchange device for an aircraft turbine engine comprising a heat exchanger, an inlet scoop with an air intake for supplying the heat exchanger, the air intake of the inlet scoop is divided into several mouthpieces, each defining an air flux supplying the exchanger.

According to some embodiments, the heat exchange device further comprises a separation profile(s) in the inlet scoop, the separation profile(s) dividing the air intake of the inlet scoop into said several mouthpieces.

According to some embodiments, the one or more separation profile(s) delimit air flux channels in the inlet scoop for each mouthpiece.

According to some embodiments, the one or more separation profile(s) are attached to the wall of the inlet scoop.

According to some embodiments, each mouthpiece is selectively opened or closed by flaps.

According to some embodiments, the exchanger is of the air-oil type.

According to some embodiments, the heat exchange device further comprises at the outlet of the heat exchanger, an outlet scoop.

The present disclosure also relates to an aircraft turbine engine comprising the heat exchange device as described above and a stream of air flux for generating a thrust reaction necessary for the flight of the aircraft, the air intake of the inlet scoop being able to take air from the stream of air flux.

According to some embodiments, the turbine engine further comprises compression, combustion and turbine stages and a wall delimiting, on the inside, a stream of primary flux and on the outside, the stream of the secondary flux , the heat exchange device being in the wall.

According to some embodiments, the most upstream mouthpiece in the direction of air flow in the stream of air flux is radially the lowest.

The use in this document of the verb “to comprise”, its variants, as well as its conjugations, can in no way exclude the presence of elements other than those mentioned. The use in this document of the indefinite article “a”, “an” or the definite article “the”, to introduce an element does not exclude the presence of a plurality of these elements.

The terms “first”, “second”, “third”, etc. are used in this document exclusively to differentiate between different elements, without implying any order between these elements.

### BRIEF DESCRIPTION OF THE FIGURES

Further features and advantages of the present disclosure will become apparent from the following detailed description, for the understanding of which reference is made to the attached figures which show:
FIG. 1, a schematic view of an exchanger according to the prior art;
FIG. 2, a schematic view of a turbine engine;
FIG. 3, a schematic view of an embodiment of a heat exchange device according to the present disclosure;
FIG. 4, a schematic view of another embodiment of the heat exchange device according to the present disclosure.

The drawings in the figures are not to scale. Similar elements are generally denoted by similar references in the figures. For the purposes of this document, the same or similar elements may bear the same references. Furthermore, the presence of reference numbers or letters in the drawings cannot be considered limiting, even when such numbers or letters are indicated in the claims.

### DETAILED DESCRIPTION OF THE EMBODIMENTS

The present disclosure relates to a heat exchange device for an aircraft turbine engine comprising a heat exchanger, an inlet scoop with an air intake for supplying the heat exchanger, the air intake of the inlet scoop being divided into a several mouthpieces each defining an air flux supplying the exchanger. This allows the inlet scoop to be divided at the air intake in order to divide the inlet velocity gradient to limit the variation of the velocity of the air upstream of the exchanger. As the air velocity at the inlet of the exchanger is more homogeneous, this allows the heat exchange within the exchanger to be maximized.

FIG. 2 illustrates an example of a cross-section of an aircraft turbine engine 100 on which it is planned to integrate a heat exchange device 1 according to the present disclosure. More specifically, this is a dual flow axial turbine engine comprising, as an example in succession, along the axis X of the turbine engine 100, a fan 110, a compression stage 120 (possibly comprising a low-pressure compressor and a high-pressure compressor), a combustion stage 130 and a turbine stage 140 (possibly comprising a high-pressure turbine and a low-pressure turbine). In operation, the mechanical power of the turbine stage 140 is transmitted via shafts 101 and 102 to the compression stage 120, as well as to the fan 110 via the shaft 101. The rotors of the compression stage rotate along Y about the axis X of the turbine engine 100 allowing them to draw in and compress the air to suitable velocities, pressures, and temperatures to the inlet of the combustion stage 130. The fan 110 is used to generate air flux in a stream of primary air flux 106 and a stream of secondary air flux 107 upstream of the compression stage 120. The air flux in the stream of primary air flux 106 is primarily intended to pass axially through the aircraft turbine engine 100, thereby supplying the combustion stage 130; the air flux in the stream of secondary air flux 107 is primarily intended to generate a thrust reaction necessary for the flight of the aircraft. An inner casing 105 delimits the stream primary of flux 106 on the inside and the stream of secondary flux 107 on the outside, with the inlet scoop 12 and the exchanger 10, for example, in the inner casing 105. The stream of secondary flux 107 is between the inner casing 105 and the outer casing 180 of the nacelle.

FIG. 3 shows a schematic view of an example embodiment of the heat exchange device 1. The device 1 comprises a heat exchanger 10. The exchanger 10 allows the cooling of certain elements of the turbine engine. For example, the exchanger 10 is of the air-oil type, allowing the oil circuits of the turbine engine 100 to be cooled by means of the air circulating therein.

In order to supply air to the heat exchanger 10, it is possible to take air circulating in a stream of air flux, for example the stream of secondary air flux 107. For this purpose, the device 1 may comprise a scoop 12 allowing air to be diverted from the stream of secondary air flux 107 towards the exchanger 10. The scoop 12 comprises an air intake 14 for supplying air from the stream of secondary air flux 107 to the exchanger 10. At the outlet of the heat exchanger 10, the device 1 comprises an outlet scoop 18 adapted to return air to the stream of secondary flux 107, according to the arrow 20 in FIG. 3. The device 1 comprising the inlet scoop 12, the exchanger 10 and the outlet scoop 18 is for example in the inner casing 105 comprising in particular the compression and combustion stages. The device 1, and in particular the exchanger 10, are for example buried in the inner casing 105.

Due to the size of the exchanger 10 buried in the inner casing 105, the inlet scoop 12 has a steep slope for conveying air to the exchanger 10. To avoid such a slope generating a velocity gradient at the exchanger inlet 10, and thus an uneven supply of air over the height of the exchanger 10, the air intake 14 of the inlet scoop 12 is divided into several mouthpieces 161, 162 each defining an air flux supplying the exchanger 10. The division of the inlet scoop 12 into several mouthpieces is directly at the air intake 14. The division of the inlet scoop 12 into several mouthpieces is immediately at the air intake 14. The air flux defined at the air intake 14 of the inlet scoop extend to the exchanger. In other words, there are several air flux feeding the exchanger from the air intake 14 of the scoop. The scoop has separate air flux from the scoop intake to the exchanger. Thus, the entire scoop is divided into separate air flux. The division of the inlet scoop 12 into several mouthpieces (on the one hand) (and on the other hand) as from the air intake 14 allows the creation of a downstream velocity gradient to be avoided in the inlet scoop 12. The division of the scoop as from the air intake 14 also prevents the air from reaching the division with a gradient already formed (which is the case in the prior art where the division is further downstream in the scoop). This results in a velocity profile at the exchanger air inlet that is balanced over the height of the exchanger, especially at the top and bottom of the exchanger. This makes it possible to obtain a velocity profile at the exchanger air inlet that is homogeneous over the height of the exchanger, particularly at the top and bottom of the exchanger. This makes it possible to supply the exchanger 10 in a more evenly distributed manner over its height according to the arrows 21; the heat exchange within the exchanger 10 is thus maximized.

Two mouthpieces 161, 162 are shown as examples in FIG. 3. By halving the air intake to the inlet scoop (thus from the air diversion in the device 1), the gradient at the inlet of the exchanger is halved; the significant velocity variance caused by the steep slope of the inlet scoop 12 before the exchanger 10 is thus limited. This results in a velocity profile at the exchanger air inlet 10 that is balanced over the height of the exchanger 10, in particular at the top and bottom of the exchanger. An improvement in the air supply to the exchanger 10 is achieved in order to maximize the exchange between the air and the oil in the case of an air-oil exchanger.

The air intake 14 opens, for example, into the stream of secondary air flux 107. The air intake 14 is divided in such a way that the mouthpieces 161, 162 are aligned in the direction of flow of the air, with one mouthpiece, 161, being further upstream in the flux of air than the other mouthpiece, 162. As the inner casing 105 has a cross-section across the streams of air flux 106 and 107 which is circular, the mouthpieces 161, 162 in the inner casing are such that the most upstream mouthpiece 161 is then radially lower than the mouthpiece 162. This allows an air flux with a sufficient velocity to enter through the most downstream mouthpiece 162 and the exchanger 10 to be supplied more evenly.

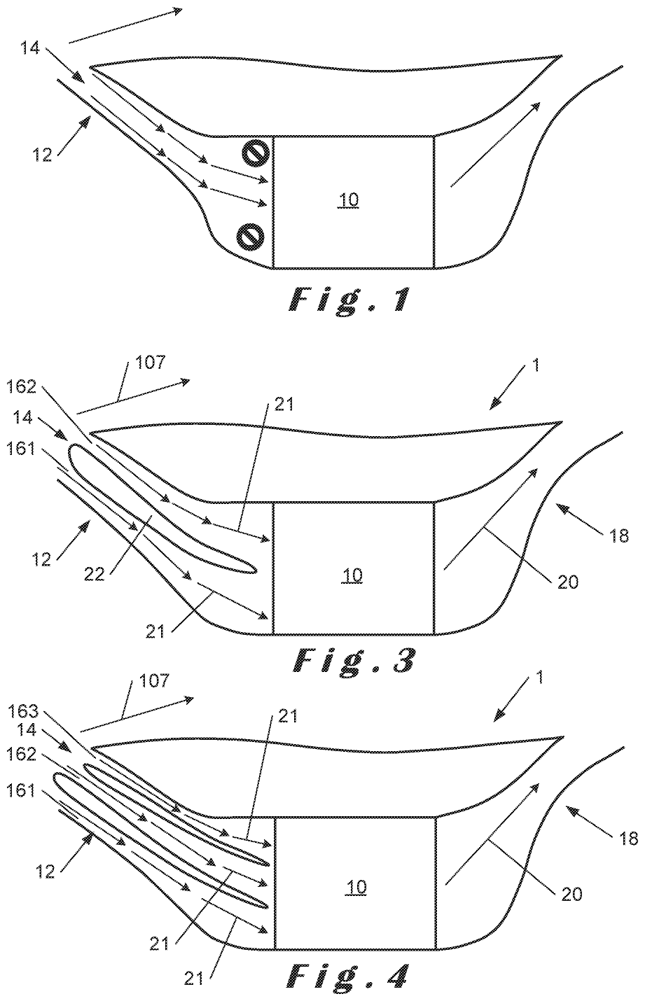

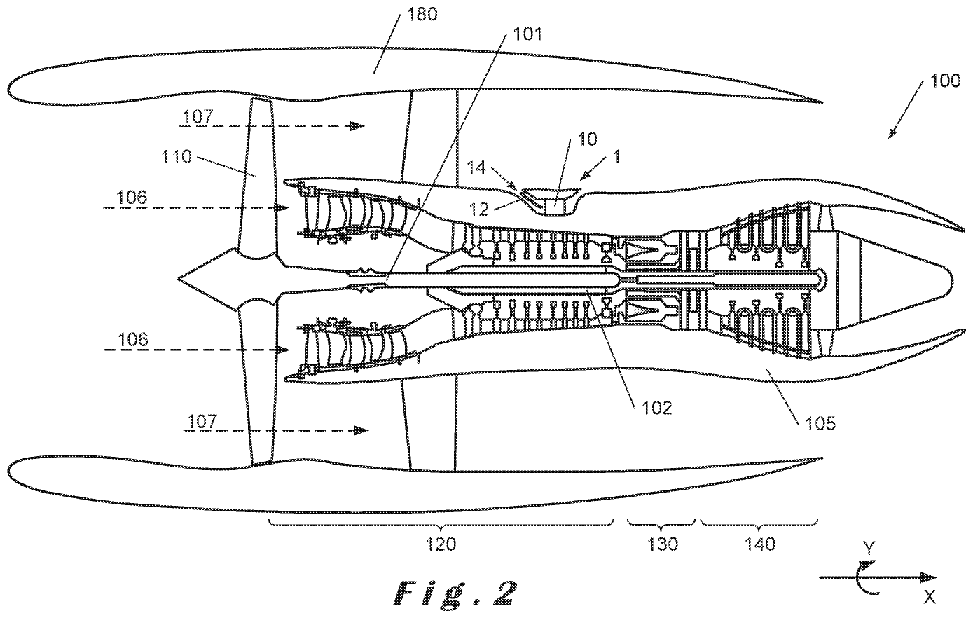

FIG. 3 shows the division of the air intake 14 into two mouthpieces, but the mouthpieces can be multiplied depending on the characteristics of the exchanger 10. FIG. 4 shows another example of the heat exchange device 1 with the same advantages, in which the air intake 14 is divided into three mouthpieces 161, 162, 163. As in FIG. 3, the air intake 14 in FIG. 4 is divided in such a way that the mouthpieces 161, 162, 163 are aligned in the direction of flow of the air; the mouthpiece 161 is the most upstream in the air flux than the mouthpiece 162, which is the most upstream than the mouthpiece 163. The mouthpieces 161, 162, 163 in the wall of the inner casing 105 are such that the most upstream mouthpiece 161 is then radially lower than the mouthpiece 162, which is itself lowest than the mouthpiece 163. This allows a flux of air with sufficient velocity to enter through each of the downstream mouthpieces 162, 163 and the exchanger 10 to be supplied more evenly according to the arrows 21. The division of the air intake of the inlet scoop ultimately makes it possible to create a double scoop when there are two mouthpieces (as in FIG. 3) or more generally, when there are even more mouthpieces (as in FIG. 4), to create a multi-inlet scoop.

The heat exchange device 1 may further comprise one or more separation profiles 22 in the scoop 12. The separation profile(s) 22 divide the air intake 14 of the scoop 12 into several mouthpieces. The separation profiles 22 allow the division of the inlet scoop 12 at its air intake 14 and guide the air flux defined at each mouthpiece to the exchanger 10. As the air flux are guided along the inlet scoop 12, the air velocities are homogeneous at the inlet of the exchanger 10. The separation profiles 22 thus delimit air flux channels in the inlet scoop 12, for each mouthpiece. According to FIG. 3, a separation profile 22 is present in the inlet scoop 12, dividing the air intake 14 into two mouthpieces 161, 162 and delimiting two air flux channels between the air intake 14 and the exchanger 10. According to FIG. 4, two separation profiles 22 are present in the inlet scoop 12, dividing the air intake 14 into three mouthpieces 161, 162, 163 and delimiting three air flux channels between the air intake 14 and the exchanger 10.

The separation profiles 22 are attached to the wall of the inlet scoop 12 and extend over the entire width of the exchanger 10. The aerodynamic profile of the separation profiles is designed to limit turbulences within the inlet scoop 12; for example, the separation profiles 22 may have an aircraft wing shape. Alternatively, the separation profiles 22 may be shaped to follow the profile of the inlet scoop 12 and the path of the air flux in the inlet scoop 12 obtained at the air intake 14. In particular, the separation profiles 22 may be shaped to follow the steep profile of the inlet scoop 12.

It is also possible to selectively open or close the mouthpieces 161, 162, 163 depending on the heat exchange requirements of the turbine engine 100. The air flux within the inlet scoop 12 can thus be created or extinguished. The channels defined in the inlet scoop 12 can thus be selectively opened or obstructed. This results in an adaptive exchanger, which takes in the air flux as required, guiding the air flux to the open mouthpieces. The selective opening or closing of the mouthpieces 161, 162, 163 is achieved for example by flaps.

The turbine engine may comprise a number of heat exchange devices 1, the air intake from the inlet scoops being divided as described. The devices 1 may be distributed in the direction of the flow of air in the stream of air flux, for example secondary, and/or along the circumference of the inner casing 105. The device 1 may also be positioned at other locations in the turbine engine and take air from other streams of air circulation than the stream of secondary air flux.

The present disclosure has been described in relation to specific embodiments, which are purely illustrative and should not be considered limiting. In general, it will be apparent to the person skilled in the art that the present disclosure is not limited to the examples illustrated and/or described above.

1. A heat exchange device for an aircraft turbine engine, comprising:
a heat exchanger; and
an inlet scoop comprising an air intake configured for supplying the heat exchanger, wherein the air intake of the inlet scoop is divided into several mouthpieces each defining an air flux supplying the heat exchanger.

2. The heat exchange device according to claim 1, further comprising one or more separation profiles in the inlet scoop, the one or more separation profiles dividing the air intake of the inlet scoop into the several mouthpieces.

3. The heat exchange device according claim 2, wherein the one or more separation profiles delimit air flux channels in the inlet scoop for each mouthpiece.

4. The heat exchange device according to claim 3, wherein the one or more separation profiles are attached to the wall of the inlet scoop.

5. The heat exchange device according to claim 1, wherein each mouthpiece is configured to be selectively opened or closed by flaps.

6. The heat exchange device according to claim 1, wherein the heat exchanger is an air-oil type.

7. The heat exchange device according to claim 1, further comprising, at an outlet of the heat exchanger, an outlet scoop.

8. An aircraft turbine engine, comprising:
a heat exchange device comprising:
a heat exchanger;
an inlet scoop comprising an air intake for supplying the heat exchanger, wherein the air intake of the inlet scoop is divided into several mouthpieces each defining an air flux supplying the heat exchanger,
wherein the air intake of the inlet scoop is configured to take air from a stream of air flux.

9. The turbine engine according to claim 8, further comprising a compression stage, a combustion stage, a turbine stage, and a wall delimiting on a first side thereof a stream of primary flux and on a second side thereof a stream of secondary flux, wherein the heat exchange device is disposed in the wall.

10. The turbine engine according to claim 9, wherein a most upstream mouthpiece of the several mouthpieces in a direction of air flow in the stream of air flux is radially the lowest.
